(19) United States
(12) Patent Application Publication
(10) Pub. No.: US 2020/0385994 A1
(43) Pub. Date: Dec. 10, 2020

(54) ADJUSTABLE SOFFIT DOOR SYSTEM

(71) Applicant: John O'Mara, McCook Lake, SD (US)

(72) Inventor: John O'Mara, McCook Lake, SD (US)

(21) Appl. No.: 16/892,363

(22) Filed: Jun. 4, 2020

Related U.S. Application Data
(60) Provisional application No. 62/857,511, filed on Jun. 5, 2019.

(51) Int. Cl. E04D 13/152; E04D 13/158

(52) U.S. Cl. CPC E04D 13/152; A01K 1/007; E04D 13/158

(57) ABSTRACT

This disclosure relates generally to an adjustable soffit door system, more particularly, and without limitation, to a method of manufacturing an adjustable soffit door system without welding and for use in livestock buildings, where the adjustable soffit door system resists warping, provides better nesting, provides better operation, and provides ease of shipping and handling.

### CROSS REFERENCE TO RELATED APPLICATIONS

This patent application claims priority to U.S. Provisional Patent Application No. 62/857,511 filed on Jun. 5, 2019, the entirety of which is incorporated herein fully by reference.

### FIELD OF THE DISCLOSURE

This disclosure relates generally to an adjustable soffit door system, more particularly, and without limitation, to a method of manufacturing an adjustable soffit door without welding and for use in livestock buildings, where the adjustable soffit door resists warping, provides better nesting, provides better operation, and provides ease of shipping and handling.

### BACKGROUND OF THE DISCLOSURE

Adjustable soffit doors are in wide use by persons in the agricultural industry, particularly those engaging in livestock rearing. The continuous and year-round nature of livestock rearing has developed a need for increased controlled ventilation in a variety of seasons and weather conditions. The use of adjustable soffit doors and methods of manufacturing the same is well known in the prior art. While other devices fulfill their respective, particular objectives, they all suffer from their own disadvantages and limitations and therefore the need remains for an adjustable soffit door and method of manufacturing the same that, among other objectives, is an improvement of the prior art. For the reasons stated above, and for other reasons stated below which will become apparent to those skilled in the art upon reading and understanding the specification, there is a need in the art for an improved adjustable soffit door and method of manufacturing the same without welding and for use in livestock buildings, where the adjustable soffit door resists warping, provides better nesting, provides better operation, and provides ease of shipping and handling.

Thus it is an object of at least one embodiment of the disclosure to provide an adjustable soffit door system and method of manufacturing the same that improves upon the state of the art.

Another object of at least one embodiment of the disclosure is to provide an adjustable soffit door system and method of manufacturing the same that is easy to use.

Yet another object of at least one embodiment of the disclosure is to provide an adjustable soffit door system and method of manufacturing that is efficient.

Another object of at least one embodiment of the disclosure is to provide an adjustable soffit door system and method of manufacturing that is cost effective.

Yet another object of at least one embodiment of the disclosure is to provide an adjustable soffit door system and method of manufacturing that is safe to use.

Another object of at least one embodiment of the disclosure is to provide an adjustable soffit door system and method of manufacturing that has a durable design.

Yet another object of at least one embodiment of the disclosure is to provide an adjustable soffit door system and method of manufacturing that has a long, useful life.

Another object of at least one embodiment of the disclosure is to provide an adjustable soffit door system and method of manufacturing that has a wide variety of uses.

Yet another object of at least one embodiment of the disclosure is to provide an adjustable soffit door and method of manufacturing that has a wide variety of applications.

Another object of at least one embodiment of the disclosure is to provide an adjustable soffit door system and method of manufacturing that can be easily utilized by a user.

Yet another object of at least one embodiment of the disclosure is to provide an adjustable soffit door system and method of manufacturing that provides a cost savings to the user.

Another object of at least one embodiment of the disclosure is to provide an adjustable soffit door system and method of manufacturing that is relatively inexpensive.

Yet another object of at least one embodiment of the disclosure is to provide an adjustable soffit door system and method of manufacturing that provides value.

Another object of at least one embodiment of the disclosure is to provide an adjustable soffit door system and method of manufacturing that is aesthetically pleasing.

Yet another object of at least one embodiment of the disclosure is to provide an adjustable soffit door system and method of manufacturing that is configured with fasteners or door stops rather than welds.

Another object of at least one embodiment of the disclosure is to provide an adjustable soffit door system and method of manufacturing that is configured to provide better nesting and operation.

Yet another object of at least one embodiment of the disclosure is to provide an adjustable soffit door system and method of manufacturing that can be used with any dimension of door or opening.

Another object of at least one embodiment of the disclosure is to provide an adjustable soffit door system and method of manufacturing that is versatile.

Yet another object of at least one embodiment of the disclosure is to provide an adjustable soffit door system and method of manufacturing that can function so as to provide increased airflow.

Another object of at least one embodiment of the disclosure is to provide an adjustable soffit door system and method of manufacturing that resists warping during the manufacturing process.

These and other objects, features, or advantages of at least one embodiment will become apparent from the specification, figures and claims.

### BRIEF SUMMARY OF THE DISCLOSURE

In an embodiment of the disclosure, an adjustable soffit door system is provided, comprising: a door frame; a plurality of door panels; a plurality of guide channels; a plurality of fasteners; a plurality of holes; at least one wire cable; at least one clamp, and at least one stiffening angle. In an another embodiment of the disclosure, a method of manufacturing an adjustable soffit door system for livestock confinements is provided, the steps comprising: laser cutting at least one door panel to a desired size; laser cutting at least one stiffening angle to a desired size; forming a hole in the at least one stiffening angle; affixing the at least one stiffening angle to the at least one door panel, laser cutting at least one guide channel support member; bending the guide channel support member to the desired angle; forming at least one hole in each of the guide channel support members; aligning the holes in the guide channel support member and the door panel; inserting a fastener through the aligned holes; and positioning the door panels in a nesting configuration.

### BRIEF DESCRIPTION OF THE DRAWINGS

FIG. 1 depicts an adjustable soffit door system according to one embodiment.

FIG. 2 depicts an adjustable soffit door system according to one embodiment.

FIG. 3 depicts an adjustable soffit door system according to one embodiment.

FIG. 4 depicts an adjustable soffit door system according to one embodiment.

FIG. 5 depicts an adjustable soffit door system according to one embodiment.

FIG. 6 depicts an adjustable soffit door system according to one embodiment.

FIG. 7 depicts an adjustable soffit door system according to one embodiment.

FIG. 8 depicts an adjustable soffit door system according to one embodiment.

FIG. 9 depicts an adjustable soffit door system according to one embodiment.

FIG. 10 depicts an adjustable soffit door system according to one embodiment.

FIG. 11 depicts three configurations of an adjustable soffit door system according to one embodiment.

FIG. 12 depicts an adjustable soffit door system including a winch installed on a building according to one embodiment.

FIG. 13 depicts an adjustable soffit door system installed on a building according to one embodiment.

FIG. 14 depicts an adjustable soffit door system according to one embodiment.

FIG. 15 depicts method for manufacturing an adjustable soffit door system according to one embodiment.

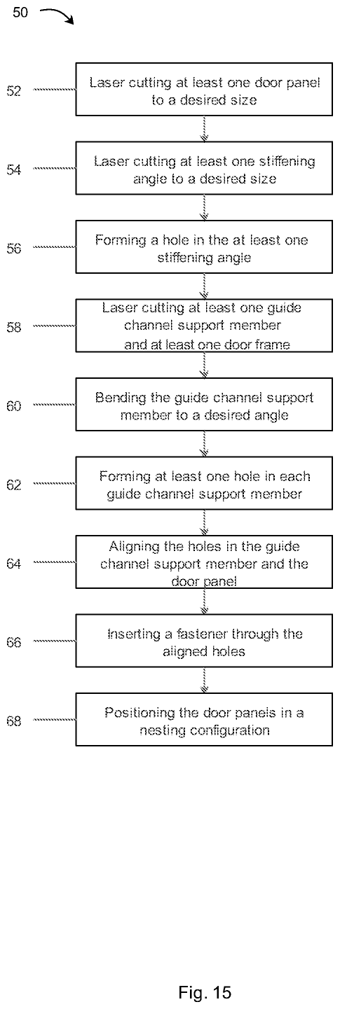

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

### Adjustable Soffit Door System

In the arrangement shown, as one example, an adjustable soffit door system 10 (or simply “system” 10) is formed of any suitable size, shape and design and is configured to affix to a building 12, such as a barn.

In the arrangement shown, as one example, for purposes of clarity, the system 10 has at least one door panel 14, at least one stiffening angle 16, at least one guide channel 18, a plurality of holes 20, a plurality of fasteners 22, a wire cable 24, a door frame 26, and optionally one or more winches 28. In the arrangement shown, as one example, system 10 is symmetrical, or generally symmetrical, or operatively symmetrical, and for this reason, unless specified otherwise, description of one side 30 of system 10 shall apply to both sides 30 of system 10 which is separated by an imaginary centerline that extends down the approximate left-to-right center of the system 10.

### Door Frame 26

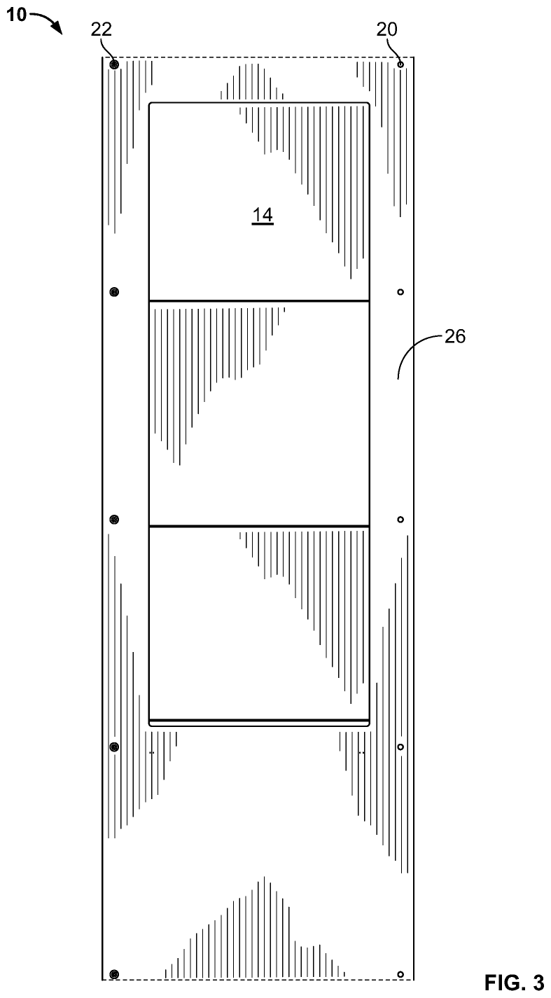

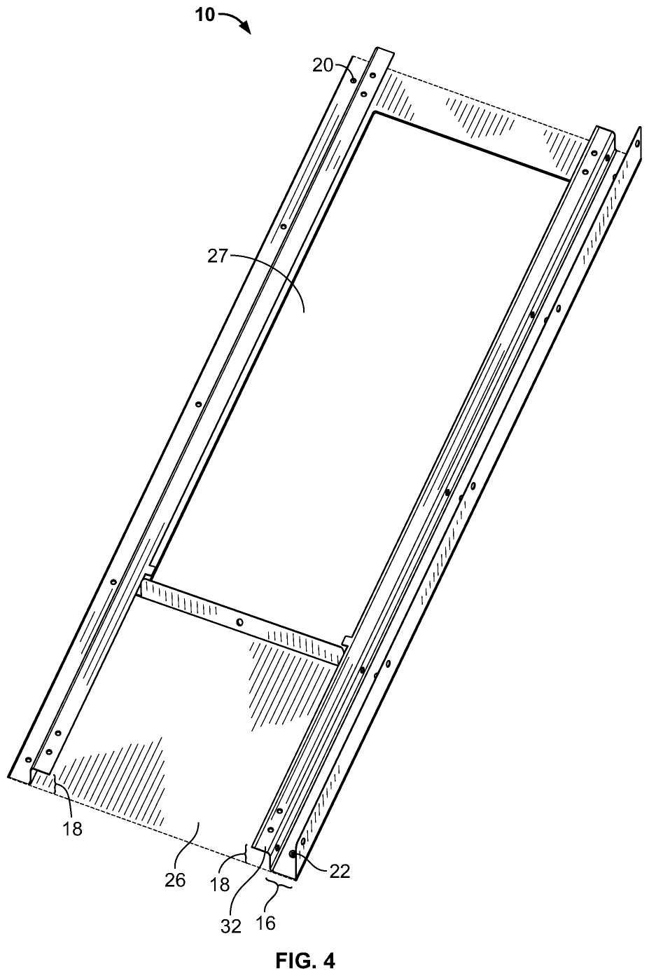

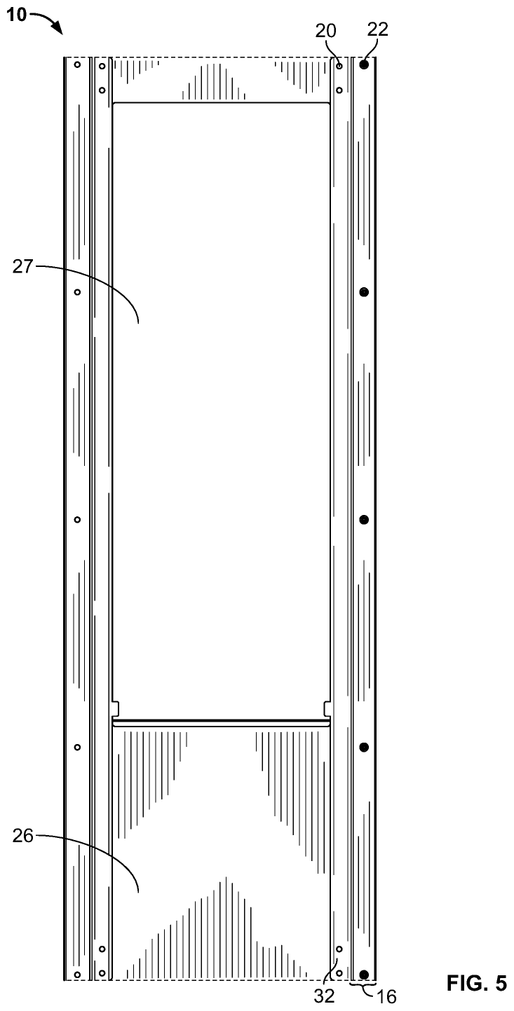

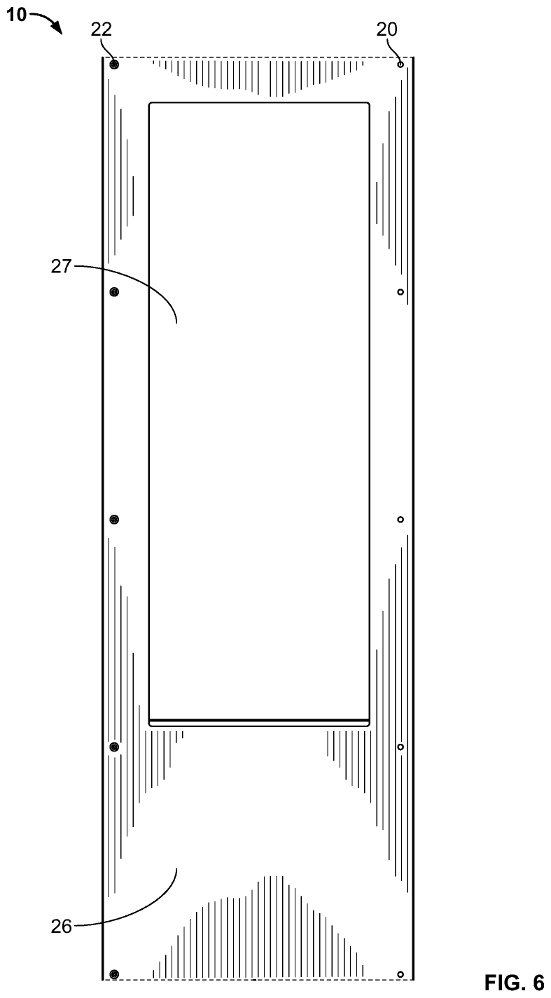

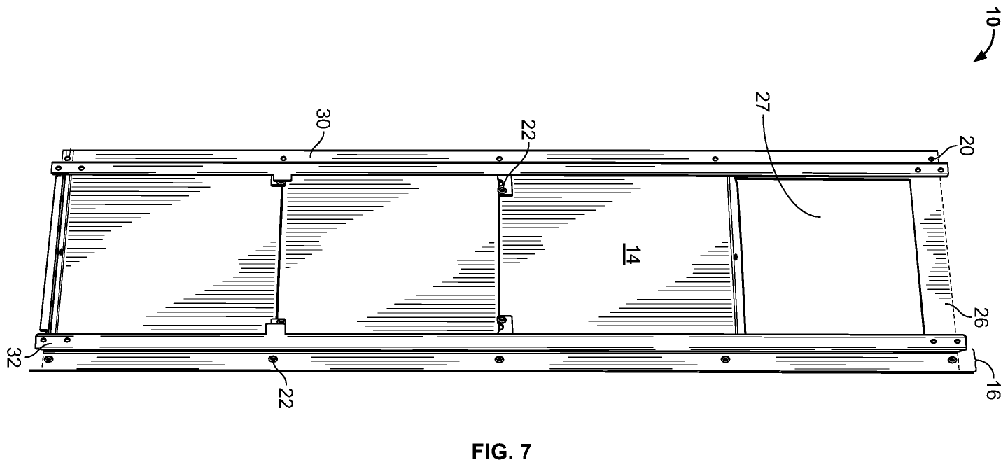

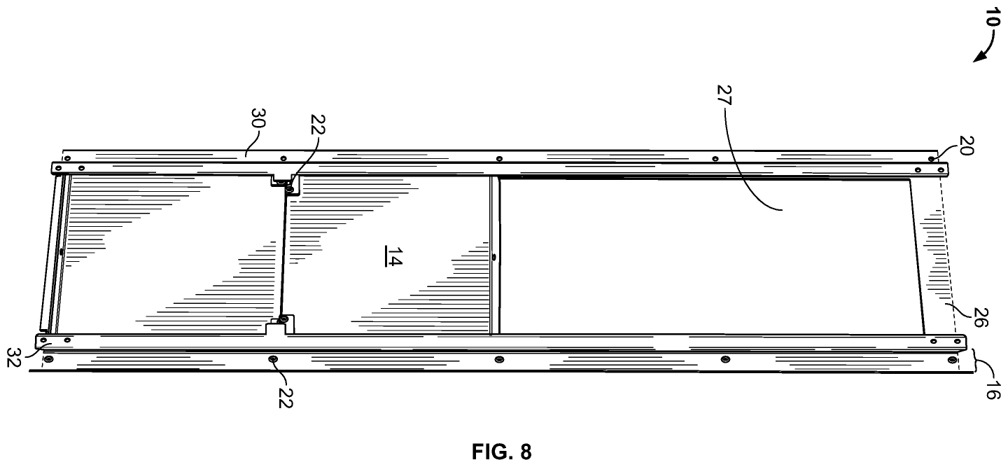

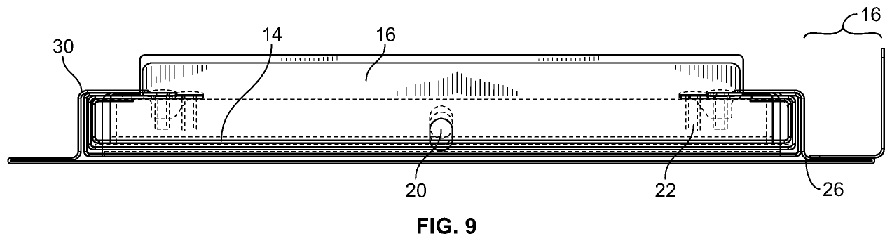

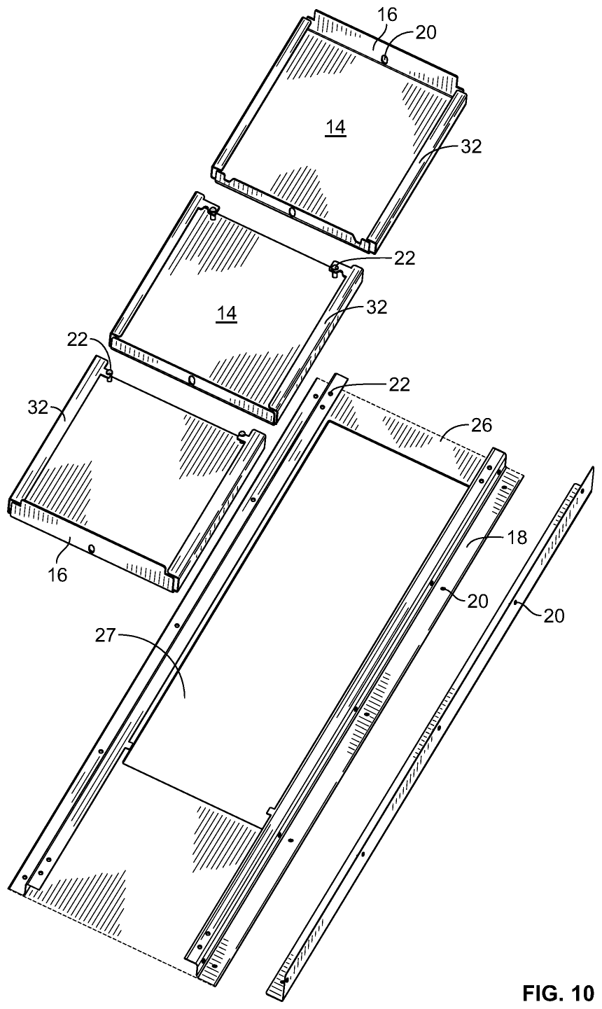

As shown in FIGS. 3-10, a door frame 26 provides a support structure for mounting and connecting other components of system 10 and also for mounting system 10 to a building 12. Door frame 26 comprises a generally flat and generally rectangular panel with a generally rectangular section cut and removed from a central portion of door frame 26 to form a void 27. One or more door panels 14 may cover void 27 or be inserted into void 27. One or more holes 20 are positioned near the edges of door frame 26, and holes 20 are configured to accept fasteners 22. Door frame 26 may be constructed from wood, metal, plastic, fiberglass, or any other suitable material without departing from the scope of the disclosure. As the soffit area of a building 12 may be any dimensions, door frame 26 and void 27 may be of any dimensions without departing from the scope of the disclosure. Door frame 26 has an outer perimeter that comprises first and second sides 30 and first and second ends 31. First and second sides 30 are generally parallel to each other and generally perpendicular to first and second ends 31. Likewise, first and second ends 31 are generally parallel to each other and generally perpendicular to first and second sides 30.

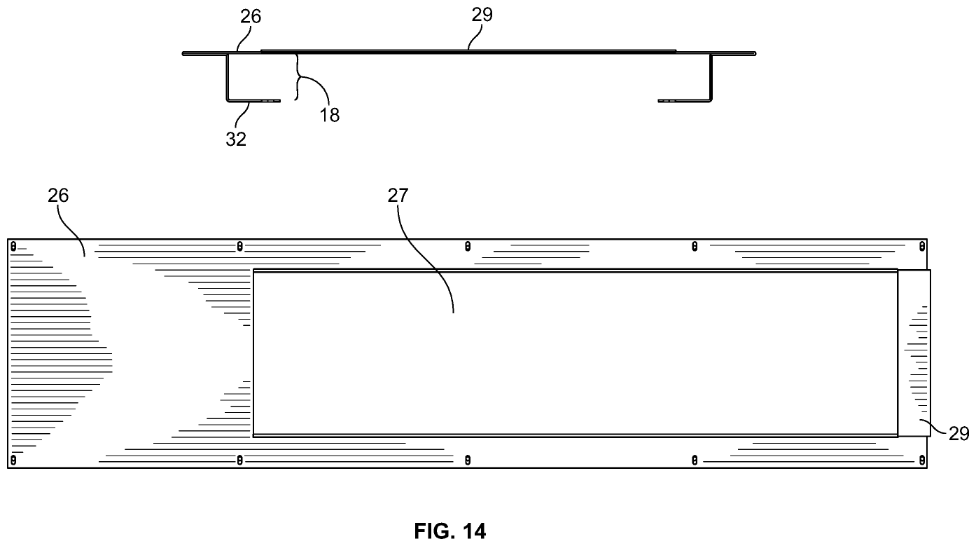

As shown in FIG. 14, in one embodiment a door frame 26 may comprise a rectangular plane measuring approximately 12 inches by 47.75 inches. Void 27 may comprise an 8.75 inch by 33.5 inch rectangular opening formed in the interior portion of door frame 26. A fold and flat 29 portion of the door frame 26 may be included to add strength to system 10 and specifically to door frame 26 without the use of a stiffening angle 16 on door frame 26. Fold and flat 29 is formed of any suitable size, shape and design and is configured to stiffen the door frame 26, add strength to the door frame 26, to provide overlap between adjacent systems 10 when multiple soffit door systems 10 are installed, and fill gaps between systems 10 caused at installation or due to warping over time. In the arrangement shown, fold and flat 29 is formed by creating a generally 180 degree angle bend in material used to create door frame 26. Fold and flat 29 may be formed when void 27 is cut from the material used to create door frame. To create fold and flat 29, the 33.5 inch sides and one 8.75 inch side are cut. A second 8.75 inch cut is made parallel to the first 8.75 inch cut, leaving an at least 1.79 inch long peninsula of material extending from the uncut 8.75 inch side of void 27. The extending material is then bent 180 degrees to form the fold and flat 29 such that 1.79 inches of material is folded over the material of door frame 26 and the surfaces of the fold and flat 29 and the door frame 26 are generally parallel to each other. Void 27 and fold and flat 29 are positioned such that fold and flat 29 extends past the edge of door frame 26 by at least approximately 0.25 inches.

### Door Panel 14

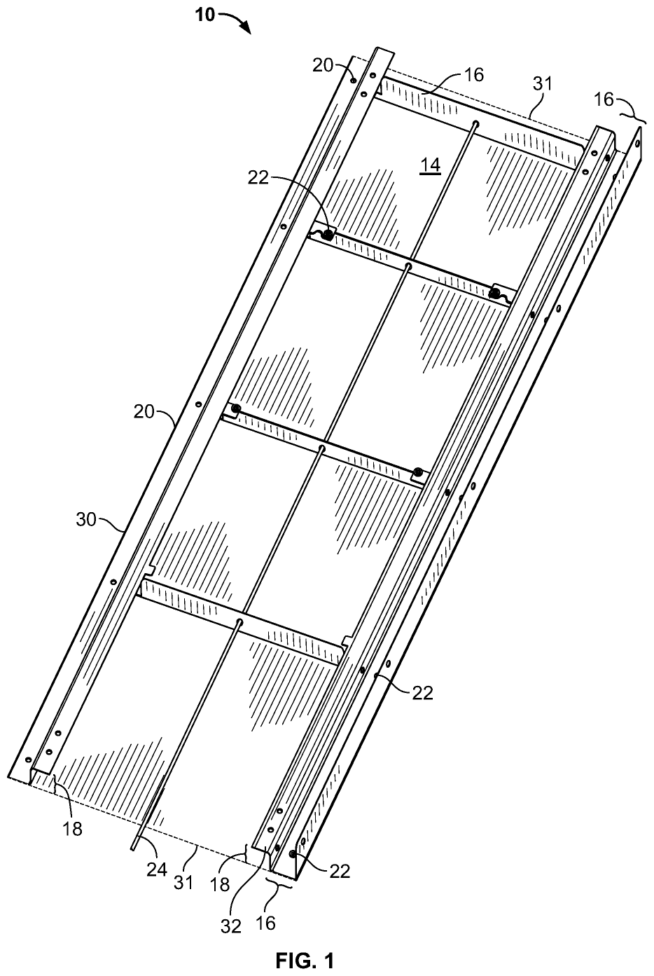

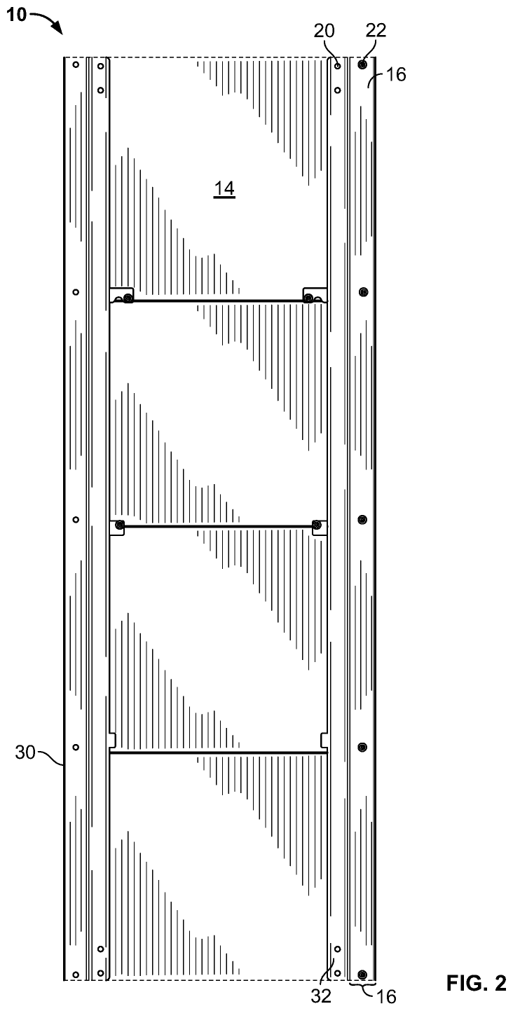

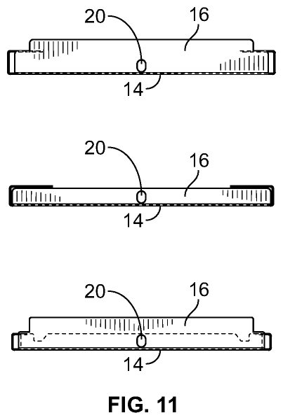

As shown in FIGS. 1-3 and 7-11, as one example, the adjustable soffit door system 10 is formed of a plurality of continuous planar members or door panels 14. Door panel 14 is a movable panel configured to be moved in a first direction to cover void 27 and prevent airflow in and out of building 12. Door panel 14 may be moved in a second direction to expose void 27 and allow airflow in and out of building 12. Door panel 14 may be formed of any suitable size, shape, and design and is configured to nest into a second, third, forth, and so on, door panel 14. In the arrangement shown, as one example, door panel 14 includes a top, bottom, and at least one hole 20.

In the arrangement shown, as one example, door panel 14 is designed to be easily assembled and installed. Additionally, in the arrangement shown, as one example, door panel 14 is configured to nest into a subsequent door panel 14, thereby providing exceptional and customizable ventilation control. In the arrangement shown, as one example, with reference to FIG. 1, a door panel 14 is generally flat and rectangular and designed to be configured with a plurality of door panels 14, if desired. Door panel 14 may be constructed from metal, wood, plastic, fiberglass, or any other suitable material without departing from the scope of the disclosure.

### Stiffening Angle 16

As shown in FIGS. 1-2, 4-5, and 7-11, as one example, door frame 26 further comprises at least one stiffening angle 16. Stiffening angle 16 is formed of any suitable size, shape and design and is configured to stiffen the door frame 26, add strength to the door frame 26, provide correct angle for attachment of the system 10 to a building 12 when structural supports are not present as part of the building 12, and to prevent warping of door frame 26 over time and correct warping occurring during the manufacturing process or shipping. In the arrangement shown, stiffening angle 16 is formed of a generally 90 degree angle connected to the bottom of a door frame 26 via a fastener 22 inserted through holes 20, welding, adhesive, or any other suitable connection method. In the arrangement shown, as one example, stiffening angles 16 are made of stainless steel; however, stiffening angles 16 may be formed of any other material without departing from the disclosure. Other materials include, but are not limited to, polymers, fiberglass, steel, aluminum, enhanced polymers, polymer composites, and the like. In the arrangement shown, a stiffening angle 16 is attached at or near the edge of a side 30 of the door frame 26. Each stiffening angle 16 is generally the same length as the sides 30 of door frame 26; however, stiffening angles 16 may be any length and may span all or part of the side 30 to which they are attached without departing from the scope of the disclosure.

A stiffening angle 16 may additionally be formed into or attached to a door panel 14 to stiffen the door panel 14, add strength to the door panel 14, provide correct positioning of door panel 14 within guide channel 18, to prevent warping of door panel 14 over time, and to correct warping of door panel 14 occurring during the manufacturing process or shipping. In the arrangement shown, stiffening angle 16 is formed of a generally 90 degree angle bend in the material of the bottom of door panel 14. Stiffening angle 16 may also be connected to the bottom of a door panel 14 via a fastener 22 inserted through holes 20, welding, adhesive, or any other suitable connection method. In the arrangement shown, as one example, stiffening angles 16 are made of stainless steel; however, stiffening angles 16 may be formed of any other material without departing from the disclosure. Other materials include, but are not limited to, polymers, fiberglass, steel, aluminum, enhanced polymers, polymer composites, and the like. In the arrangement shown, a stiffening angle 16 is attached at or near an edge of a door panel 14. The stiffening angle 16 is generally the same width as the door panel 14; however, stiffening angles 16 may be any length and may span all or part of the width of a door panel 14 to which it is attached without departing from the scope of the disclosure.

Each door panel 14 may have one or two stiffening angles 16. In one embodiment, the door panel 14 closest to the first end 31 of door frame 26 has two stiffening angles 16 with one stiffening angle 16 affixed at or near the edge of each end of the door panel 14, and any additional door panels 14 of the system 10 has one stiffening angle 16 where the stiffening angle 16 is affixed at or near the edge of the end of the door panel 14 that is furthest from the first end 31 of door frame 26. Adjacent door panels 14 are assembled such that fasteners 22 inserted at or near the edge of the end of the door panel 14 that is closed to the first end of door frame 26 overhang the stiffening angle 16 of the adjacent door panel 14, thus allowing system 10 to be moved to an open configuration. By assembling the door panels 14 in this manner, adjacent door panels 14 are configured to nest together when system 10 is in an open configuration.

### Guide Channel 18

System 10 further comprises at least one guide channel 18. In one embodiment, a first guide channel 18 is positioned adjacent to a first side 30 of door frame 26, and a second guide channel 18 is positioned adjacent to a second side 30 of door frame 26. The one or more guide channels 18 provide a structure for holding the one or more door panels 14 in proper position and guiding door panels 14 during opening and closing. The structural details of the guide channel 18 are illustrated in FIG. 1 and include an elongated, rigid support member 32 in the form of an angle or other structural member created by intricate cutting, bending and forming of the raw door frame 26 material or secured to the door panel 14 via welding, fasteners 22, or any other suitable attachment method. Guide channel 18 comprises a slot or groove which is created in the space enveloped by support member 32 and door frame 26. Support member 32 is formed of any suitable size, shape and design and where a plurality of door panels 14 and a plurality of support members 32 are utilized, support members 32 are of a size, shape, and design so as to facilitate nesting of doors, as shown in FIG. 1.

### Holes 20

In the arrangement shown, as one example door frame 26, stiffening angles 16, and guide channel support member 32 include a plurality of holes 20. Holes 20 are formed of any suitable size, shape and design and are configured to receive a fastener 22, as described below. Additionally, holes 20 are included on the stiffening angle 16 of door panel 14 and are configured to receive a wire cable 24, as described below. Holes 20 may be drilled, punched, milled, routed, or formed by any other methods of forming holes in material without departing from the scope of the disclosure.

### Fasteners 22

In the arrangement shown, as one example, fastener 22 is formed of any suitable size, shape, and design, and is configured to be inserted into holes 20 of the door frame 26, door panel 14, stiffening angle 16, or guide channel support member 32. Fasteners 22 connect components of system 10 together and also function as a “door stop,” stopping the extension of door panel 14 within guide channel 18 or door frame 26, while also allowing door panel 14 to nest fully when the system 10 is fully open. For purposes of this application, the term “fastener” and “door stop” may be used interchangeably.

In the arrangement shown, as one example, the fastener (door stop) 22 is a generally elongated rivet. In a further embodiment, the fastener 22 may be any type of instrument utilized to attach to the surface of the door panel 14 or guide channel 18, while limiting the range of motion of the door panel 14 within the guide channel 18, or door frame 26 including, but not limited to, a bolt, screw, or the like.

In a further embodiment, the fastener 22 is generally cylindrical elongated member having a first threaded end and a head. First threaded end and head are in coaxial alignment with one another. That is, the center axis of rotation of the first threaded end and head are in alignment with one another, despite the fact that the diameters or shapes or features of the first threaded end and the head may differ. First threaded end and head may have the same diameter or different diameters. Also shown in this example is a head positioned in the end of the fastener 22. Head is any feature or device that allows for the threaded fastener 22 to be grasped and rotation to be imparted on the threaded fastener 22. In the arrangement shown, as one example, head is generally cylindrical in shape and has a diameter slightly larger than the diameter of the first threaded end. This head includes a plurality of flat surfaces on opposing sides of the head. These flat surfaces allow for a wrench or other tool to grasp the head and impart torque thereon. This can be useful during the installation process. It is hereby contemplated for use that head can take on any other form, such as a hex-head member, a square head member, a recessed hexagonal socket, a recessed square socket, a recessed flat head feature that receives a flat head screw driver, a recessed Philips head feature that receives a Phillips head screw driver, a slot, a pair of crossed slots, or any other feature that can be used to impart rotation. In this arrangement, when the first threaded end is inserted within the guide channel 18, the head extends outward from the guide channel 18, thereby facilitating easy access to the head. In this arrangement, once the first threaded end is inserted into the guide channel 18, a tool grasps the head thereby imparting rotation on fastener 22 or preventing rotation of the fastener 22.

In a still further embodiment, the door stop 22 may be formed as a part of the surface of the door panel 14 or guide channel 18. For example, the door stop 22 may be formed by creating an approximately 90 degree bend inward toward the door panel.

### Wire Cable 24

Wire cable 24 is inserted through holes 20 of the stiffening angles 16 of door panels 14, and movement of wire cable 24 causes door panels 14 to be moved between open and closed configurations. Wire cable 24 may comprise a length of uncoated metallic wire. In this arrangement, wire member 24 is formed of a material that resists corrosion so as to provide a long useful life. In another arrangement, wire member 24 is coated with a rubber or plastic like material. In an arrangement, as is shown, for example, the wire cable 24 is threaded through holes 20 located on the stiffening angle 16 of each door panel 14, so as to assist in facilitating the opening and closing of the system. The ends of wire cable 24 may attach to one or more winches 28. By winding wire cable 24 in a first direction using a first winch 28, door panels 14 are moved in a first direction to cover void 27 and prevent airflow in and out of building 12. By winding wire cable 24 in a second direction using a second winch 28, door panels 14 are moved in a second direction to expose void 27 and allow airflow in and out of building 12. Wire cable 24 must minimally be of sufficient length to span the length of the soffit area of building 12 that is covered by system 10 with additional length needed to span the distance from the soffit area of building 12 to winch 28 and still additional length needed to securely wind the end of wire cable 24 around winch 28.

### Clamps 25

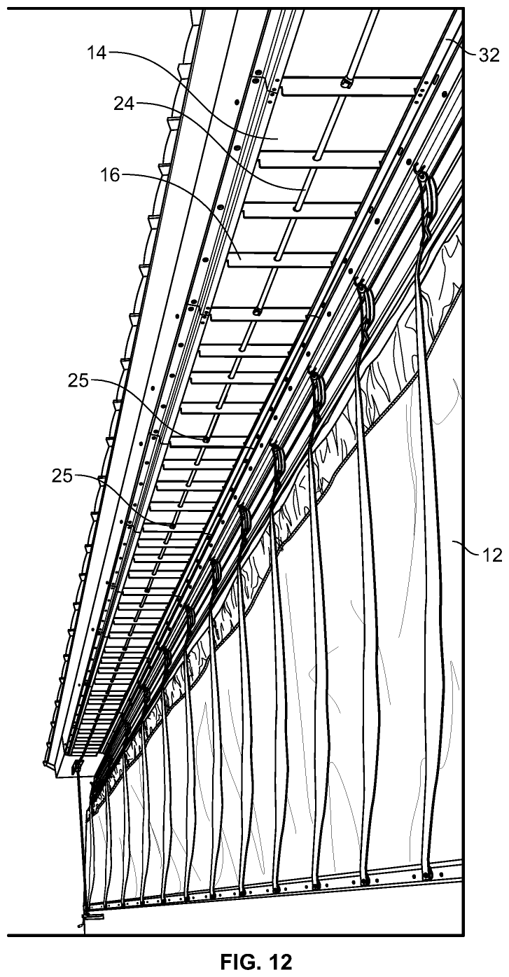

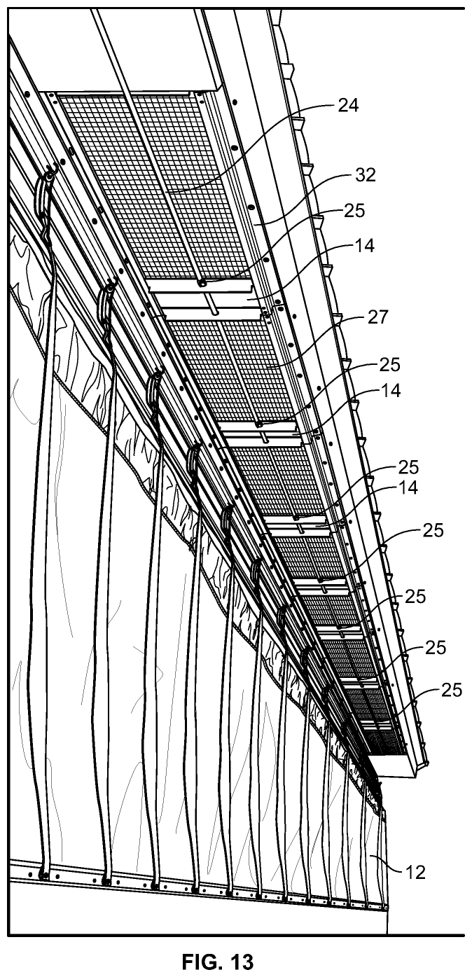

As shown in FIGS. 12 and 13, at least one clamp 25 is secured around wire cable 24 adjacent to stiffening angle 16 of door panel 14 such that clamp 25 remains in a fixed position on wire cable 24 and does not slide along wire cable 24. Clamp 25 may comprise a clip or any other type of fastener capable of being secured to wire cable 24 without departing from the scope of the disclosure. One clamp 25 may be placed on each side of stiffening angle 16, allowing door panel 14 to be moved in a first direction to cover void 27 and in a second direction to expose void 27.

When multiple door panels 14 are used along the soffit of a building 12, clamps 25 may be placed on the wire cable 24 on one or both sides of the stiffening angle 16 of each door panel 14, or clamps 25 may be placed on the wire cable 24 on one or both sides of a select number of door panels 14. For example, in one embodiment, clamps 25 may be placed on the wire cable 24 adjacent to the stiffening angle 16 of the door panel 14 on one end of system 10, effectively putting a clamp 25 on every fourth door panel 14 and leaving three stiffening angle 16 and door panel 14 combinations free of clamps 25 between each stiffening angle 16 and door panel 14 combination that has a clamp 25. By spacing clamps 25 in this manner, the door panels 14 which have clamps 25 are caused to move when wire cable 24 is moved, but wire cable 24 is free to pass through the holes 20 of stiffening angles 16 that do not have clamps 25. When a stiffening angle 16 and door panel 14 combination having a clamp 25 engages a stiffening angle 16 and door panel 14 combination that does not have a clamp 25, one of the door panels 14 nests on top of the other, the stiffening angles 16 rest against each other, and the stiffening angle 16 and door panel 14 combination without a clamp 25 is pulled along by the stiffening angle 16 and door panel 14 combination that does have a clamp 25. If another stiffening angle 16 and door panel 14 combination is similarly encountered as wire cable 24 continues to move, the newly encountered combination similarly nests with the already nested stiffening angle 16 and door panel 14 combinations. Such nesting action continues until the motion of wire cable 24 stops. Such motion causes system 10 to move into an open configuration, allowing void 27 to be exposed and air to flow in and out of the building 12.

### Winch 28

Winch 28 includes a winch frame or simply “frame” 36, a winch drum or simply “drum” 38, and braking system (not shown). Frame 36 is configured to be mounted to building 12 or to a platform or other structure that is attached to building 12. Winch drum 38 mounts to frame 36, and provides a rotatable mechanism for spooling wire cable 24 as system 10 is moved between open and closed configurations. Winch drum 38 also provides storage for extra lengths of wire cable 24. Braking system is configured to stop movement of wire cable 24 once the system 10 is in the desired configuration.

Winch 28 is preferably installed at or above operator level, with wire cable 24 running upwards from drum 38 in order to reduce wear of wire cable 24 and to eliminate slack in wire cable 24 and spooling problems like backlash. In some embodiments, winch 28 is operated using a motor that rotates the drum 38 to allow wire cable 24 to be spooled onto or released from the drum 38. When a motor is used, the motor is frequency controlled, giving full control over motor speed and torque. In some embodiments, the winch 28 may be electric, such as that which is described in U.S. Pat. No. 7,185,881, which is hereby incorporated by reference in its entirety. In other embodiments, the winch 28 may be operated manually via a hand crank coupled to the drum 38. Winch 28 may also be equipped with an arrangement for manual release of the braking system. This manual release may be actuated directly at winch 28. To ensure correct wire spooling, winch 28 is preferably sized such that only one layer of wire cable will be spooled on drum 38.

### In Operation:

In one arrangement, as is shown, system 10 is positioned in the soffit vents of a building 12, such as a barn or livestock confinement building. System 10 is fastened to building 12 trusses or rafters through holes 20 along side 30. Stiffening angle 16 is affixed to the door frame 26 and is fastened to the exterior wall of the building 12, to support the system 10 and facilitate the system 10 to remain in a fixed and usable position. Each subsequent system 10 fastened to the exterior of the building 12 overlaps the fold and flat 29 of the adjacent system 10. Once in this position, the operator may use a winch 28 to open and close the door panels 14 of the system 10 to the desired ventilation level. When the system 10 is fully open, the door panels 14 nest in such a way to reduce the coverage area of the door panels 14 by 75%, thus increasing airflow accordingly to meet barn ventilation requirements.

As previously described, a first winch 28 may be operated to move wire cable 24 in a first direction, causing system 10 to be placed in a closed configuration. A closed configuration of system 10 is shown in FIG. 12. A second winch 28 may be operated to move wire cable 24 in a second direction, causing system 10 to be placed in an open configuration. An open configuration of system 10 is shown in FIG. 13.

To open system 10 to expose void 27 and allow air to flow in and out of building 12, the first winch 28 is released and the second winch 28 is operated such that wire cable 24 is pulled in a second direction and spooled around the drum 38 of the second winch 28. As wire cable 24 moves, clamps 25 installed on wire cable 24 cause stiffening angles 16 installed on door panels 14 to move along with the wire cable 24 and clamp 25. When a stiffening angle 16 and door panel 14 combination having a clamp 25 engages a stiffening angle 16 and door panel 14 combination that does not have a clamp 25, one of the door panels 14 nests on top of the other, the stiffening angles 16 rest against each other, and the stiffening angle 16 and door panel 14 combination without a clamp 25 is pulled along by the stiffening angle 16 and door panel 14 combination that does have a clamp 25. If another stiffening angle 16 and door panel 14 combination is similarly encountered as wire cable 24 continues to move, the newly encountered combination similarly nests with the already nested stiffening angle 16 and door panel 14 combinations. Such nesting action continues until all door panels 14 are completely nested or the motion of wire cable 24 stops. Such motion causes system 10 to move into an open configuration, allowing void 27 to be exposed and air to flow in and out of the building 12. When fully open, all door panels 14 of the system 10 are stacked one on top of the other, exposing void 27 to the maximum extent possible.

To close system 10 to cover void 27 and prevent air from flowing in and out of building 12, the second winch 28 is released and the first winch 28 is operated such that wire cable 24 is pulled in a first direction and spooled around the drum 38 of the first winch 28. As wire cable 24 moves, the first door panel 14 which is closest to the first end of the door frame 26 is also pulled in the first direction due to clamps 25 installed on wire cable 24 adjacent to the stiffening angle 16 attached closest to the first end of the door frame 26. When the stiffening angle 16 installed furthest from the first end of the door frame 26 on this first door panel 14 encounters the overhanging fasteners 22 of the adjacent second door panel 14, the adjacent second door panel is also pulled in the first direction along with wire cable 24. When the stiffening angle 16 installed furthest from the first end of the door frame 26 on the second door panel 14 encounters the overhanging fasteners 22 of the adjacent third door panel 14, the adjacent third door panel is also pulled in the first direction along with wire cable 24. In such a way, the door panels 14 are pulled in the first direction out of their nested configuration and extend to cover the void 27. Such extending action continues until all door panels 14 are fully extended or the motion of wire cable 24 stops. In this manner system 10 moves into a closed configuration, covering void 27 and preventing air from flowing in and out of the building 12. When fully closed, all door panels 14 of the system 10 are positioned next to each other and void 27 is completely covered.

### Method of Manufacturing:

According to an embodiment of the disclosure, the disclosure further provides for a method 50 of manufacturing an adjustable soffit door system 10. In one embodiment, the method 50 begins at step 52 with laser cutting at least one door panel 14 to a desired size.

The method 50 then proceeds to step 54 with cutting at least one stiffening angle 16 to a desired size.

The method 50 then proceeds to step 56 with forming a hole 20 in the at least one stiffening angle 16. The hole 20 may be formed by drilling, punching, milling, or any other suitable method for creating a hole 20 in material.

The method 50 then proceeds to step 58 with laser cutting at least one guide channel support member 32 and laser cutting at least one door frame 26. t is contemplated that laser cutting is performed on a two dimensional sheet of material which will be formed in later steps to result in two dimensional components.

The cutting step 58 is followed by a series of bending steps to result in the three dimensional structure of the present disclosure. For example, the bending steps may include step 60 bending the guide channel support member 32 to the desired angle. For example, a generally rectangular piece of material cut in step 58 may be bent along the longer dimension of the material at or near the center of the material to form a generally 90 degree angle, thus forming the guide channel support member 32.

The method 50 then proceeds to step 62 with forming at least one hole 20 in each of the guide channel support members 32.

The method 50 then proceeds to step 64 with aligning the holes 20 in the guide channel support member 32 and the door panel 14; and step 66 with affixing a fastener 22 through the aligned holes 20.

Finally, the method 50 proceeds to step 68 with assembling or positioning the door panels 14 in a nesting configuration. Adjacent door panels 14 are assembled such that fasteners 22 inserted at or near the edge of the end of the door panel 14 that is closed to the first end of door frame 26 overhang the stiffening angle 16 of the adjacent door panel 14, thus allowing system 10 to be moved to an open configuration. By assembling the door panels 14 in this manner, adjacent door panels 14 are configured to nest together when system 10 is in an open configuration.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the disclosure. It is intended that this disclosure be limited only by the following claims, and the full scope of equivalents thereof.

From the above discussion, it will be appreciated that the adjustable soffit door system presented improves upon the state of the art. That is, the adjustable soffit door system presented: improves upon the state of the art; is easy to use; is efficient; is cost effective; is safe to use; has a durable design; has a long, useful life; has a wide variety of uses; has a wide variety of applications; can be easily used by a user; provides a cost savings to the user; is relatively inexpensive; provides value; is aesthetically pleasing; is configured to provide exceptional and customizable ventilation control, among countless other features, aspects, improvements and objectives.

### SELECTED REFERENCE NUMERALS

10—Adjustable soffit door system
12—Building or barn
14—Door panel
16—Stiffening angle
18—Guide Channel
20—Hole
22—Door Stop/Fastener
24—Wire cable
25—Clamp
26—Door frame
27—Void
28—Winch
29—Fold and flat
30—Side
31—End
32—Guide channel support member
36—Winch frame or frame
38—Winch drum or drum
50—Method of manufacturing system 10
52—Laser cutting at least one door panel to a desired size
54—Laser cutting at least one stiffening angle to a desired size
56—Forming a hole in the as least one stiffening angle
58—Laser cutting at least one guide channel support member and at least one door frame
60—Bending the guide channel support member to the desired angle
62—Forming at least one hole in each guide channel support member
64—Aligning the holes in the guide channel support member and the door panel
66—Inserting a fastener through the aligned holes
68—Positioning the door panels in a nesting configuration

What is claimed:

1. An adjustable soffit door system configured to be moved between an open configuration and a closed configuration comprising:
a door frame comprising a first side and a second side, wherein the first side and second side are generally parallel to each other, and wherein the door frame further comprises a generally rectangular void at or near the center of the door frame;
a first guide channel support member affixed to the first side of the door frame and forming a first guide channel between the first guide channle support member and the door frame;
a second guide channel support member affixed to the second side of the door frame and forming a second guide channel between the second guide channel support member and the door frame;
a plurality of movable door panels configured to slide between the first guide channel and the second guide channel;
at least one stiffening angle affixed to each door panel wherein each stiffening angle comprises at least one hole; and
at least one wire cable wherein the wire cable is inserted into the at least one hole in the at least one stiffening angle.

2. The adjustable soffit door system of claim 1 wherein the plurality of door panels further comprise at least one hole, through which a fastener is received.

3. The adjustable soffit door system of claim 1, wherein the plurality of guide channels further comprise at least one hole, through which a fastener is received.

4. The adjustable soffit door system of claim 1, wherein the plurality of doors includes at least three doors.

5. The adjustable soffit door system of claim 1, wherein an operator of the door uses a winch to open or close the door to a desired configuration.

6. A method of manufacturing an adjustable soffit door for livestock confinements, the steps comprising:
laser cutting at least one door panel to a desired size;
laser cutting at least one stiffening angle to a desired size;
forming a hole in the at least one stiffening angle;
laser cutting at least one guide channel support member;
bending the guide channel support member to the desired angle;
forming at least one hole in each of the guide channel support member;
aligning the holes in the guide channel support member and the door panel;
inserting a fastener through the aligned holes; and
positioning the door panels in a nesting configuration.

7. The method of claim 6 wherein laser cutting at least one door panel comprises cutting a first and second door panel, cutting at least one stiffening angle comprises cutting a first and second stiffening angle

8. The method of claim 7 further comprising attaching the first stiffening angle to the first door panel and attaching the second stiffening angle to the second door panel.

9. The method of claim 8 wherein the fastener is inserted into a hole in the second door panel such that the fastener overhangs the first stiffening angle on the first door panel.
